(19) United States
(12) Patent Application Publication
(10) Pub. No.: US 2017/0039504 A1
(43) Pub. Date: Feb. 9, 2017

(54) SYSTEMS AND METHODS TO ADMINISTER A DISPATCH PLATFORM AFFILIATE PROGRAM

(71) Applicants: Nadav Ullman, Fairfield, CT (US); Michael Magnoli, Bristol, CT (US); Thomas Bachant, Storrs, CT (US); Joseph Thibeault, Manchester, CT (US)

(72) Inventors: Nadav Ullman, Fairfield, CT (US); Michael Magnoli, Bristol, CT (US); Thomas Bachant, Storrs, CT (US); Joseph Thibeault, Manchester, CT (US)

(21) Appl. No.: 14/817,536

(22) Filed: Aug. 4, 2015

(51) Int. Cl. G06Q 10/06; G01S 19/13; G07B 15/00; H04L 29/08; G06Q 50/32

(52) U.S. Cl. CPC G06Q 10/063118; H04L 67/10; G06Q 50/32; G07B 15/00; G01S 19/13

(57) ABSTRACT

According to some embodiments, information about a first enterprise having a first fleet of vehicles is used to create a first customer interface to receive ride requests from customers via at least one communication network. Similarly, information about a second enterprise (located geographically remote from the first enterprise) having a second fleet of vehicles is used to create a second customer interface. An affiliate link may be established between the first enterprise and the second enterprise. When a ride request is received via the first customer interface, and it is determined that the first customer is located geographically proximate to the second enterprise, it may be arranged for a vehicle from the second fleet to be assigned to the request based on the affiliate link between the first enterprise and the second enterprise.

### FIELD

Some embodiments relate to systems and methods associated with a vehicle dispatch platform. More specifically, some embodiments are directed to systems and methods to administer a dispatch platform affiliate program.

### BACKGROUND

A customer may provide a ride request to a dispatcher. For example, a customer might call a dispatcher's telephone number to request a ride to a nearby restaurant, hotel, or airport. The dispatcher may then assign a particular vehicle from a fleet of available vehicles to fulfill the customer's request. In some cases, customers may prefer to use a smartphone or web portal to submit a ride request. To serve these customers, a dispatcher might independently develop a smartphone application and/or web portal to assign vehicles to ride requests. Alternatively, the dispatcher might hire a third party developer to produce the smartphone application and/or web portal. In either case, development of these products is a time consuming and expensive process. Moreover, a dispatcher will typically only serve a particular geographic area (e.g., a town or city), and, as a result, will be unable to serve a customer who requests a ride from a location outside that area. Accordingly, methods and mechanisms to efficiently, accurately, and automatically facilitate administration of a dispatch platform affiliate program may be provided in accordance with some embodiments described herein.

### SUMMARY

According to some embodiments, systems, methods, apparatus, computer program code and means may facilitate administration of a dispatch platform affiliate program. According to some embodiments, information about a first enterprise having a first fleet of vehicles is used to create a first customer interface to receive ride requests from customers via at least one communication network. Similarly, information about a second enterprise (located geographically remote from the first enterprise) having a second fleet of vehicles is used to create a second customer interface. An affiliate link may be established between the first enterprise and the second enterprise. When a ride request is received via the first customer interface, and it is determined that the first customer is located geographically proximate to the second enterprise, it may be arranged for a vehicle from the second fleet to be assigned to the request based on the affiliate link between the first enterprise and the second enterprise.

Some embodiments provide: means for receiving information about a first enterprise having a first fleet of vehicles; means for creating a first customer interface for the first enterprise, the first customer interface being adapted to receive, at a first dispatch platform, ride requests from customers via at least one communication network; means for receiving information about a second enterprise having a second fleet of vehicles, the second enterprise being located geographically remote from the first enterprise; means for creating a second customer interface for the second enterprise, the second customer interface being adapted to receive, at a second dispatch platform, ride requests from customers via at least one communication network; means for establishing an affiliate link between the first enterprise and the second enterprise; means for receiving, via the first customer interface, a ride request from a first customer; means for automatically determining that the first customer is located geographically proximate to the second enterprise; and based on the affiliate link between the first enterprise and the second enterprise, means for arranging for a vehicle from the second fleet of vehicles to be assigned to the ride request.

### BRIEF DESCRIPTION OF THE DRAWINGS

FIG. 1 is a block diagram of a system according to some embodiments.

FIG. 2 is a flow diagram of a process in accordance with some embodiments.

FIG. 3 illustrates a dispatch platform enterprise information sign up display in accordance with some embodiments.

FIG. 4 illustrates a dispatch platform enterprise information auto dispatching display according with some embodiments.

FIG. 5 illustrates a dispatch platform enterprise information integrations display in accordance with some embodiments.

FIG. 6 illustrates a dispatch platform enterprise information pricing display according with some embodiments.

FIG. 7 illustrates a dispatch platform enterprise information coupon code display in accordance with some embodiments.

FIG. 8 illustrates a dispatch platform enterprise information zones display according with some embodiments.

FIG. 9 illustrates a dispatch platform enterprise information drivers display in accordance with some embodiments.

FIG. 10 illustrates a dispatch platform enterprise information map display according with some embodiments.

FIG. 11 illustrates a dispatch platform enterprise information new bookings display in accordance with some embodiments.

FIG. 12 illustrates phases of a ride according with some embodiments.

FIG. 13 is a flow diagram of a dispatch platform method in accordance with some embodiments.

FIG. 14 illustrates a customer ride request display on a smartphone according with some embodiments.

FIG. 15 illustrates a customer ride scheduling display on a web portal according with some embodiments.

FIG. 16 is a flow diagram of a customer application method in accordance with some embodiments.

FIG. 17 illustrates a driver application display according with some embodiments.

FIG. 18 illustrates a payment display according with some embodiments.

FIG. 19 is a flow diagram of a driver application method in accordance with some embodiments.

FIG. 20 is an affiliate program information flow diagram accordance with some embodiments.

FIG. 21 is a block diagram of an apparatus according to some embodiments.

FIG. 22 illustrates a portion of a tabular affiliate database that might be stored in accordance with some embodiments.

### DETAILED DESCRIPTION

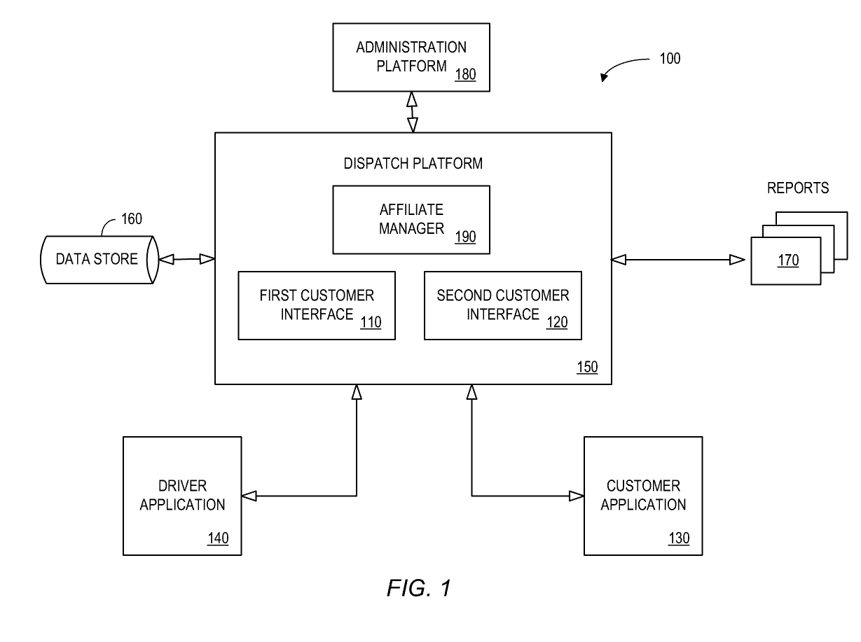

A customer may, for example, call a dispatcher's telephone number to request a ride to a nearby destination, and the dispatcher assign a particular vehicle from a fleet of available vehicles to fulfill the customer's request. Some customers, however, may prefer to use a smartphone or web portal to submit a ride request. To serve these customers, a dispatcher might independently develop a smartphone application and/or web portal, or hire a third party to do so, but in either case, development of these products is a time consuming and expensive process. Moreover, a dispatcher will typically only serve a particular geographic area (e.g., a town or city), and, as a result, is unable to serve a customer who requests a ride from a location outside that area. To avoid such problems, methods and mechanisms to efficiently, accurately, and automatically facilitate administration of a dispatch platform affiliate program may be provided in accordance with some embodiments described herein. FIG. 1 is block diagram of a system 100 according to some embodiments of the present invention. In particular, the system 100 includes a dispatch platform 150 that may create and/or manage a first customer interface 110 and a second customer interface 120 (e.g., associated with two different enterprises, each having a fleet of vehicles). According to some embodiments, information about the enterprises might be stored in a data store 160. According to some embodiments, multiple dispatch platforms and/or customer interfaces may be co-hosted in a cloud environment. According to other embodiments, separate, stand-alone implementations may be provided.

The dispatch platform 150 may receive a ride request from a customer application 130. For example, a customer might transmit a request, via the first customer interface 110, to be picked up at a particular location using his or her smartphone. The dispatch platform 150 may then evaluate the ride request and assign a vehicle from the first enterprise's fleet of vehicles to pick up the customer. This assignment may be performed, for example, via a driver application 140 (e.g., executing on his or her smartphone). Any of the devices described herein might be associated with, for example, a Personal Computer (PC), a laptop computer, a smartphone, an enterprise server, a server farm, and/or a database or similar storage devices. The dispatch platform 150 may, according to some embodiments, be associated with a limousine, taxi, or livery service provide.

According to some embodiments, an “automated” dispatch platform 150 may facilitate responses to ride requests. For example, the dispatch platform 150 may automatically generate and transmit message indicating that a particular driver should pick up a customer at a particular location. As used herein, the term “automated” may refer to, for example, actions that can be performed with little (or no) intervention by a human.

As used herein, devices, including those associated with the dispatch platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Note that the first and second customer interfaces 110, 120 may be locally stored (and/or hosted) or reside remote from the dispatch platform 150. As will be described further below, information in the dispatch platform 150 may be used by the dispatch platform 150 for various purposes. According to some embodiments, the dispatch platform 150 communicates information about rides to an automated system, such as by transmitting an electronic file to an administration platform 180, a customer or driver device, an email server, a workflow management system, a predictive model, etc.

Although a single dispatch platform 150 is shown in FIG. 1, any number of such devices may be included. Moreover, various devices described herein might be combined according to embodiments of the present invention. For example, in some embodiments, the dispatch platform 150 and data store 160 might be co-located and/or may comprise a single apparatus.

All systems and processes discussed herein may be embodied in program code stored on one or more computer-readable media. Such media may include, for example, a floppy disk, a CD-ROM, a DVD-ROM, magnetic tape, OR solid state Random Access Memory (RAM) or Read Only Memory (ROM) storage units. Embodiments are therefore not limited to any specific combination of hardware and software.

The administration platform 180 may be used, for example, to create reports 170 and facilitate analytics, customize a point of sale, support call-in bookings, add and edit rides, manage drivers, support vehicle tracking, and/or customize company settings. Note that the dispatch portal 150 and/or administration platform 180 might support manual dispatching and/or an auto assignment of responses to ride requests (e.g., using an algorithm), support billing customers, allow an administrator to supervise drivers and a fleet of vehicles, generate revenue breakdown and analytics, and/or provide an overview of company operations.

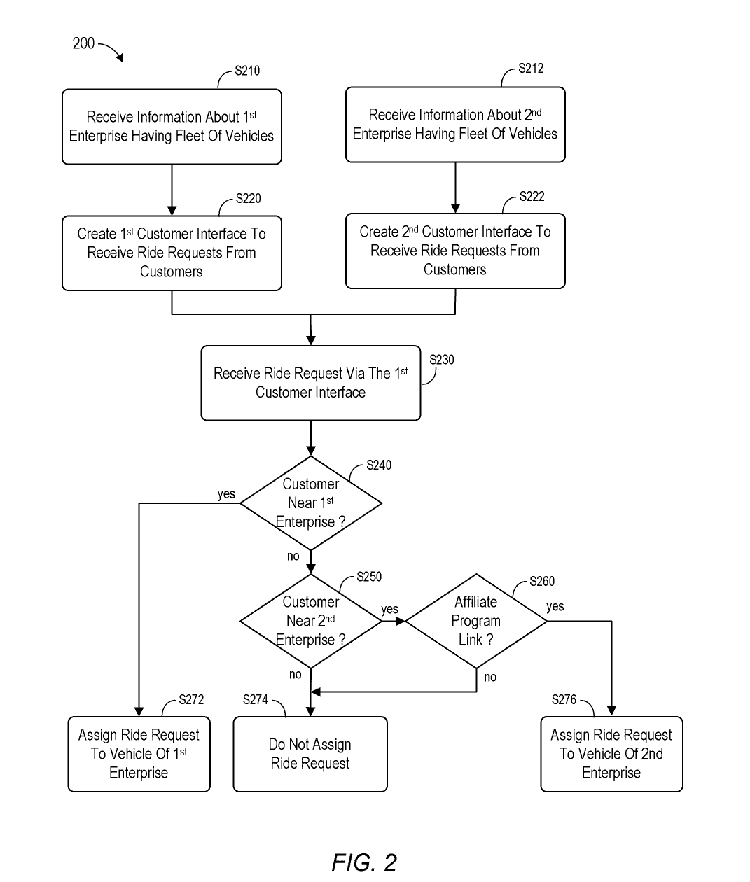

According to some embodiments, an affiliate manager 190 may be used to allow a ride request, received via the first customer interface 110, to be picked up by a vehicle associated with the second enterprise. For example, FIG. 2 is a flow diagram of a process 200 that might be associated with the system 100 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable. Although two enterprises are described with respect to FIG. 2 for clarity, any number of enterprises may be supported.

At S210, information about a first enterprise having a first fleet of vehicles may be received. The information may be used at S220 to create a first customer interface for the first enterprise. The first customer interface may be adapted to receive, for example, ride requests from customers via at least one communication network. The first customer interface may be associated with, for example: a smartphone application, a web portal, a smartwatch, a handheld computer, a table computer, a set-top box, and/or a gaming device. The received information about the first enterprise might include, for example, an enterprise name, enterprise contact information, auto-dispatching information, service information, coupon code information, zone information, driver information, account information, GPS information, and/or map information. Similar steps are performed for a second enterprise at S212 and S222. Note that the first and second customer interfaces may be independently branded (e.g., having different company logos, screen layouts, workflows, etc.).

At S230, a ride request is received from a customer via the first customer interface. The ride request might be, for example, a request for an immediate pickup or a request to schedule a future pickup.

If it is determined that the first customer is located geographically proximate to the first enterprise at S240, the request is assigned to, and the customer will be picked up by, a vehicle from the first enterprise at S272. If it is determined that the first customer is not near the first enterprise at S240, it is determined if the customer is near the second enterprise at S250. If it is determined that the first customer is not located geographically proximate to the second enterprise at S250, the ride request is simply not assigned at S274. That is, no vehicles are available to service the customer.

If it is determining that the first customer is located geographically proximate to the second enterprise at S250, it is determined whether or not there is an affiliate program link between the two enterprises at S260. If not, the ride request is again not assigned at S274. If, however, there is an affiliate program link between the two enterprises at S260, the ride request will be assigned to a vehicle of the second enterprise at S276 (even though the customer submitted the request to the first enterprise). The assignment of the vehicle from the second fleet to the ride request might include, for example, displaying the ride request to drivers of the second fleet as a “potential pickup” and receiving from one of the drivers an acceptance of the potential pickup.

Note that multiple affiliate links might be qualified to respond to a particular ride request (and one of the links might be selected based on business logic, bidding information, a round-robin approach, vehicle location information, etc.). Also note that according to some embodiments, an affiliate link might comprise a “one way” link.

According to some embodiments, a dispatch portal might further facilitate a transfer of a benefit from the second enterprise to the first enterprise in exchange for the ride referral. The benefit might comprise, for example, a monetary payment, a credit, etc. Note that a monetary payment might have a value based on, for example, a pre-determined amount (e.g., $3.00), a percentage of a fee paid from the first customer to the second enterprise, and/or a compensation formula (e.g., a large number of referrals might result in a larger, or smaller, payment). According to some embodiments, the dispatch portal may also facilitate payment from the customer to the second enterprise (e.g., via his or her credit card or pre-established account). Moreover, some embodiments may further collect rating information from the customer and/or a driver who picked up the customer.

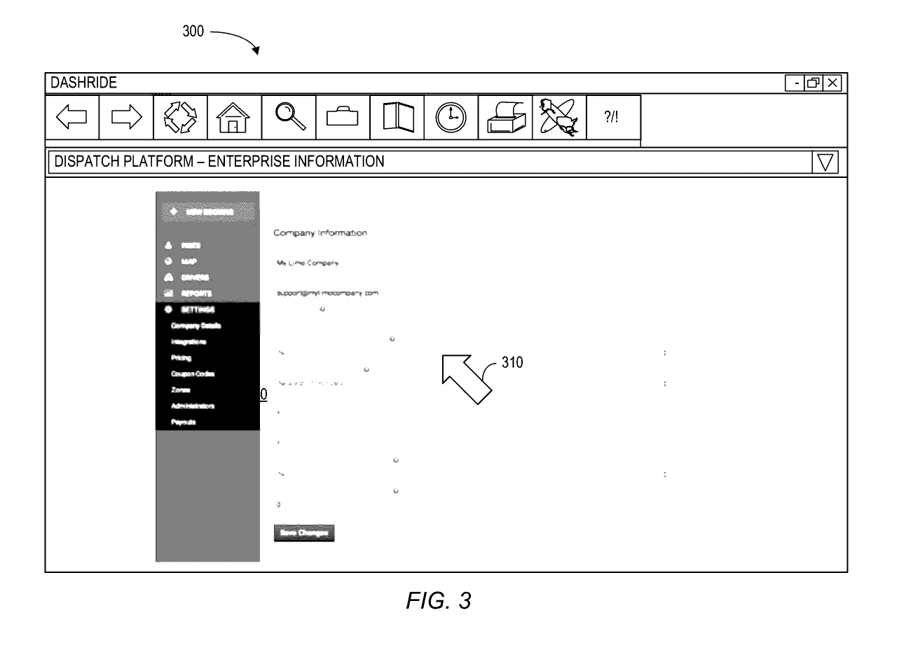

FIG. 3 illustrates a dispatch platform enterprise information sign up display 300 in accordance with some embodiments. In a “Settings” portion on the left hand-side of the display 300, basic enterprise information may be entered, such as a company name and a support email address. The support email address might be, for example, an email that an enterprise wants customers using to reach it (and may automatically appear in a customized customer interface application created for the enterprise). Similarly, the enterprise may enter a link to an “Email Banner” image that will appear on emails sent to clients, such as ride receipts.

In other portions of the display 300, an enterprise might us a pointer 310 or touchscreen to indicate if a client should confirm an email address when he or she books a ride (whether it is through a custom application, a web portal/plug-in, or a home-office reservation tool). An enterprise might prefer to have customers confirm emails, for example, to help ensure that the information is accurate. The display 300 may also be used to enter pricing information, such as minimum billable hours and/or minimum billable miles.

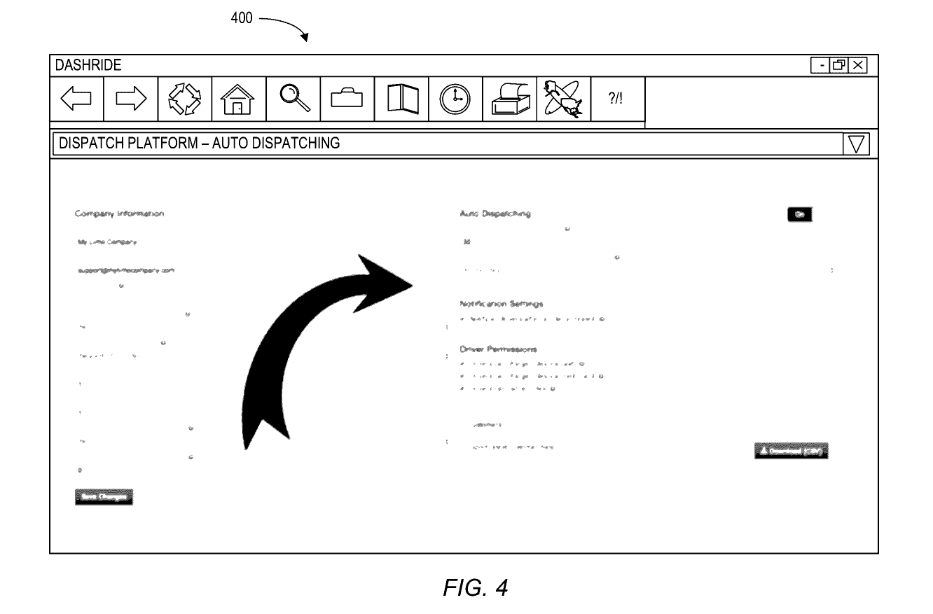

FIG. 4 illustrates a dispatch platform enterprise information “auto-dispatching” display 400 according with some embodiments. When turned on, auto-dispatching may help find the closest available driver for a ride request, and send the request to that drive. In a text field, the enterprise may define an auto-assignment interval (the time, in seconds, during which a driver must accept a ride). When set to 30 seconds, for example, the closest available driver is given 30 seconds to accept the ride before the ride is then offered to the second closest driver for the next 30 seconds.

An enterprise may also define a delayed dispatching interval. This interval, in minutes, may determine how many minutes prior to the pick-up time will the ride begin dispatching out to your drivers. This may, for example, help with pre-scheduled rides. Under notification settings, an enterprise may define whether all drivers should be notified of a new ride request, or just one driver at a time. Some companies might choose to notify all of drivers at once, allowing ride requests to be accepted on a first-come, first-serve basis. The driver permissions let an enterprise set the control a driver has after accepting a ride, which includes an ability to charge, an ability to accept cash, and/or an ability to cancel rides.

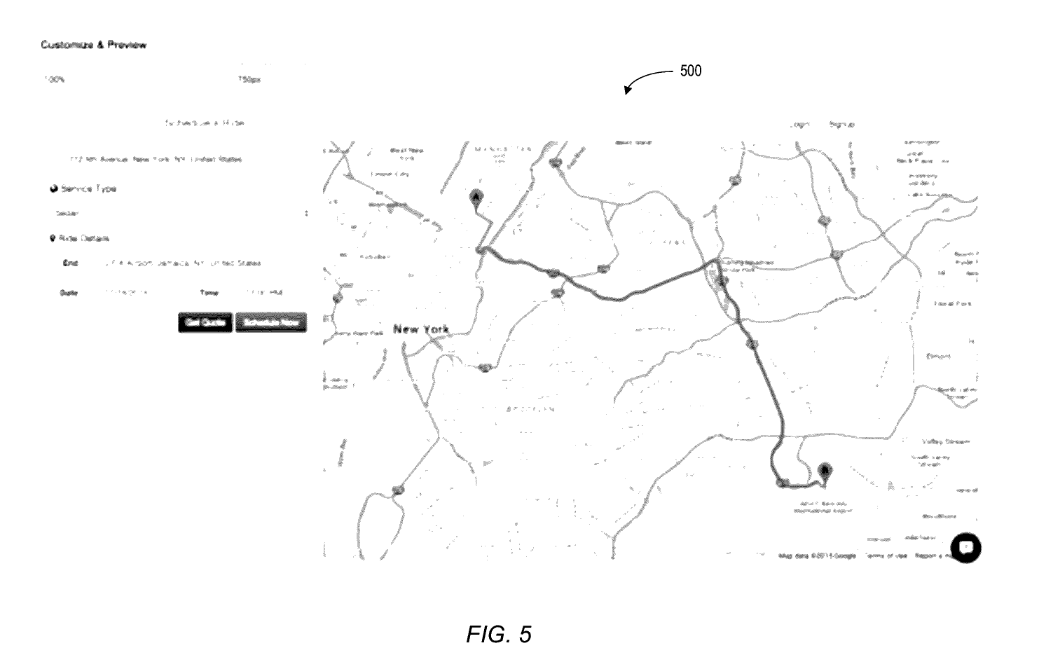

FIG. 5 illustrates a dispatch platform enterprise information integrations display 500 in accordance with some embodiments. On the integrations display 500, an enterprise may configure a ride reservation widget. A string of code may be copied and pasted to a website, and the booking form will automatically appear allowing your customers to book rides via the enterprise's website. The form sends the rides over to the dispatching center, or to the driver, depending on the defined dispatching settings. The enterprise can customize the information collected on this web application. Moreover, the enterprise can customize how large the form will be on a website in a text box. When a ride is booked via website with this form, the request may be dispatched in the same way as if the customer used a customized smartphone application. This web widget may also be used by client to get quotes for rides prior to scheduling.

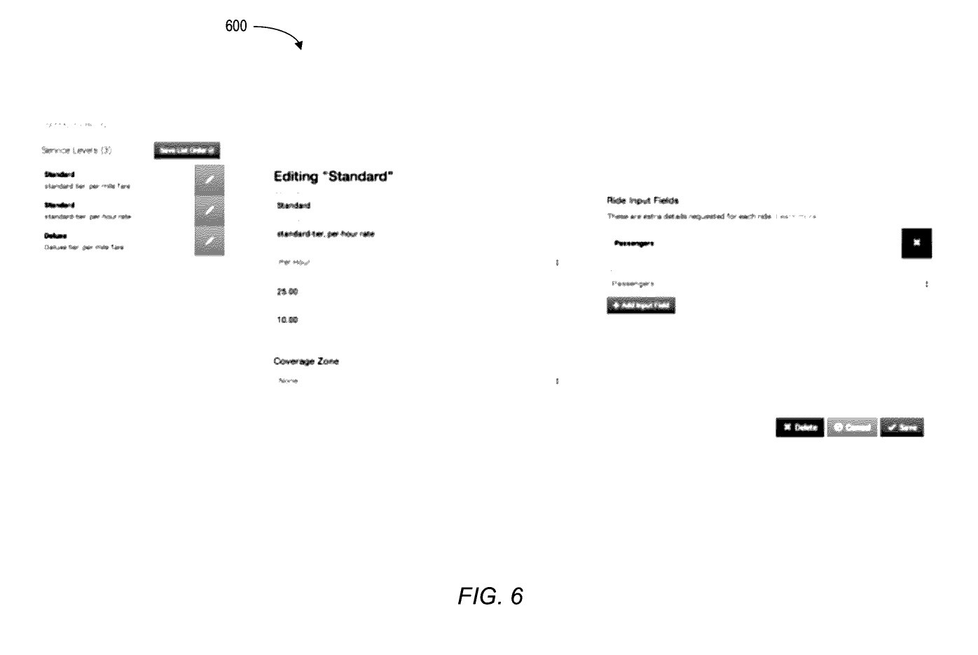

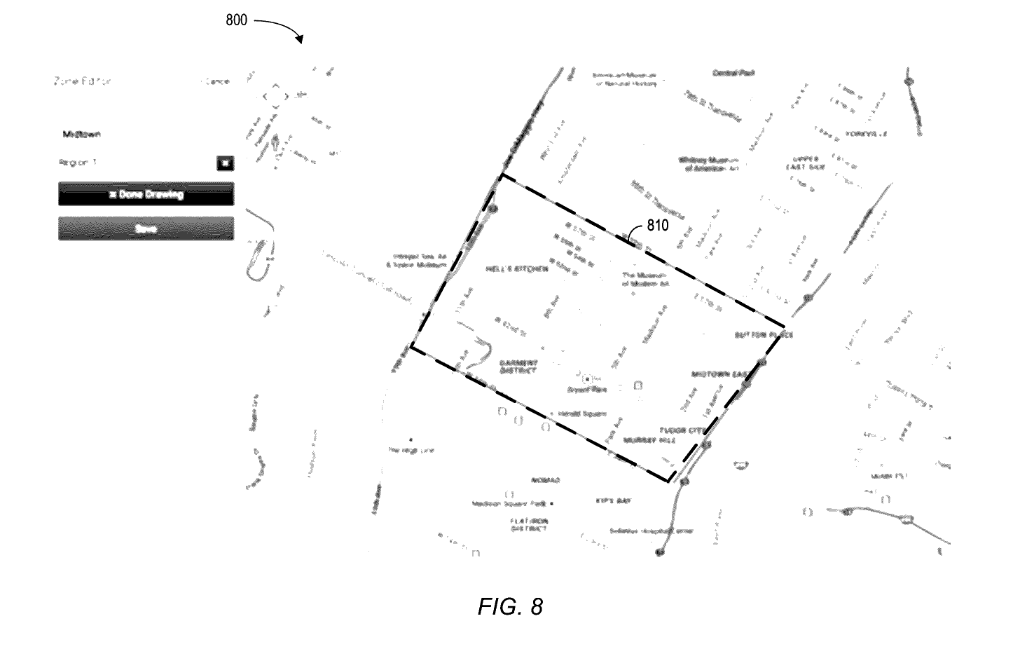

FIG. 6 illustrates a dispatch platform enterprise information pricing display 600 according with some embodiments. The display 600 may be used by the enterprise to define pricing and to control the information that is collected by a call center, as well as which information will appear on a web widget and/or mobile application. The display 600 may be used to facilitate and support the pre-existing operations of an enterprise. Each type of service that is offer is called a “Service Level” with an associated price. For example, an enterprise might offer a Sedan that has an $8.00 pickup charge plus $2.50/mile. An SUV, however, might have a $15.00 pickup charge plus $4.00/mile. Within each Service Level, the enterprise may decide which information it would like to collect from clients. To collect more information from clients, a new “Ride Input Fields” may be added, such as “Flight information,” “number of passengers,” “Coupon Codes,” and/or “Extra Details.” When this information is changed, the change will automatically appear on the customized customer interface application, on the web site widget, and for the call center. As a result, the enterprise is consistently collecting the information needed from everyone. If an enterprise has different pricing and/or service levels in different areas, it may specify different coverage zones, and each coverage zone may be correlated such that only those service levels are show in the applications (as described with respect to FIG. 8).

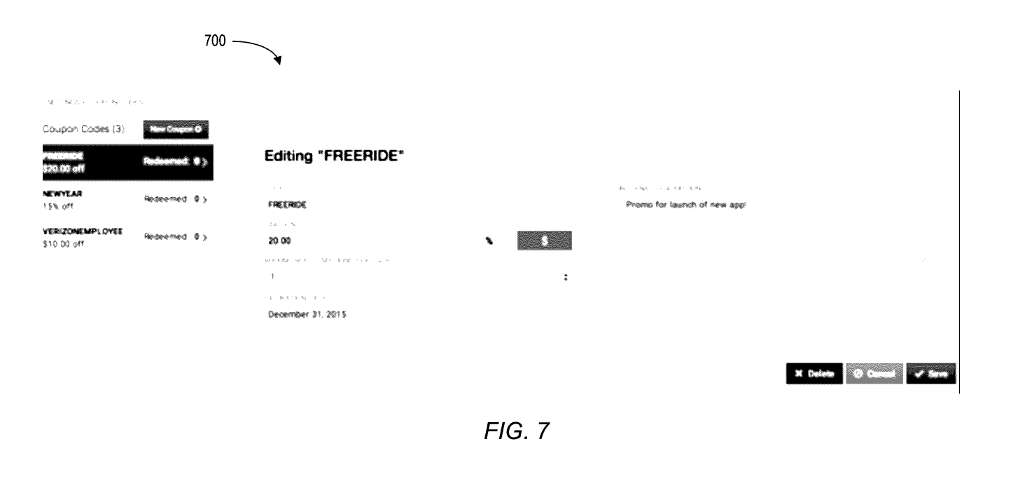

For example, FIG. 7 illustrates a dispatch platform enterprise information coupon codes display 700 in accordance with some embodiments. Coupon codes may let an enterprise offer promotions to customers. To create a new coupon, the display 700 may be used to add a Ride Input field labeled “Coupon Codes” to the appropriate Service Levels. The Coupon Codes tab may then be used to enter the name of the Code, the discount that will apply to the ride, the maximum times per user the enterprise will to allow customers to redeem it, and an expiration date for the code. The promotional codes may be defined as either a percentage off the total ride or dollar amount discount. A common promotion that companies is “First ride free up to $20.” These types of coupons may help an enterprise promote the application and spread the word to new customers. Once the Coupon Code is created, and added to the Ride Input field in Pricing, the discounts will automatically be applied to rides as appropriate.

FIG. 8 illustrates a dispatch platform enterprise information zones display 800 according with some embodiments. For example, if an enterprise only offers Mini Vans in certain areas, the enterprise can associate Mini Vans with a zone 810 once it defines the zone 810 via the display 800. Similarly, if an enterprise has different price levels in different areas for the same vehicle (e.g., the same vehicle type), it can make multiple service levels for that vehicle, and set-up each one with individual pricing in a coverage zone. Even if an enterprise offers the same vehicles at the same price, regardless of zone, it may still be helpful to define a large zone of the company's entire coverage area. This way, when client tries to request a ride outside this zone, it may alert the user that the enterprise does not have service in that area. Setting up an overall enterprise coverage zone may also facilitate use of an affiliate network program according to some embodiments.

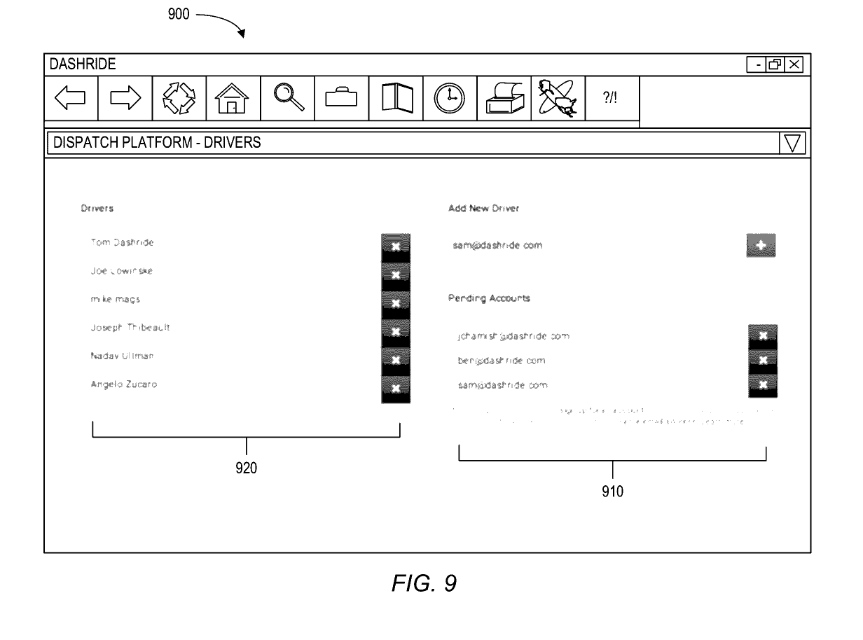

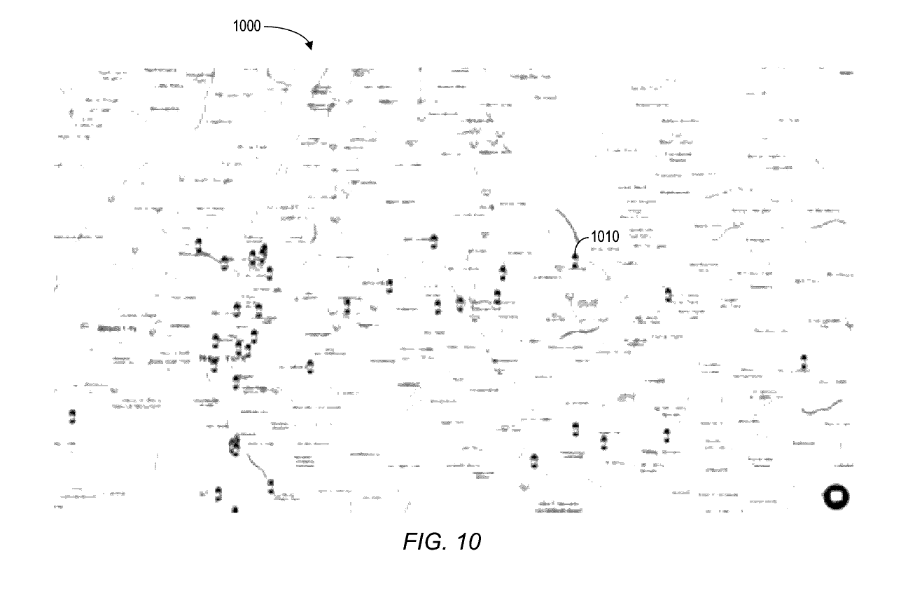

FIG. 9 illustrates a dispatch platform enterprise information drivers display 900 in accordance with some embodiments. To add drivers, an enterprise may enter in an email address of each driver in the fleet. After adding in new emails, the driver's email will appear in a list of Pending Drivers 910. After a new driver gets added, he or she must download the driver application to his or her phone (e.g., from the iTunes® store, or the Google Play® Store). After the driver downloads the application, he or she may select ‘I'm New to Dispatch Platform’ to create an account. If the driver already has an account—then he or she may instead select LOG IN. Once a new driver's signs up, he or she is moved over from the PENDING list 910 to the DRIVERS list 920. Each driver that has done this will remain in the drivers list 920 (unless an administrator selects a red X button to the right of the displayed email, resulting in removal of the driver). Once a driver signs up, his or her vehicle may also show up on the map display 1000 described with respect to FIG. 10. Depending on which dispatching method an enterprise selected, drivers may now receive ride requests as they are dispatched.

In the same way that an enterprise can add and remove drivers via email, an enterprise may do the same with dispatcher and account administrators. For example, according to some embodiments, an enterprise can select a “Dispatcher and Admins” icon. Once an enterprise adds an email, instead of downloading the driver application from the application store (as driver would do), the dispatchers or administrator might access a web page and click ‘SIGNUP’ to create a new account.

FIG. 10 illustrates a dispatch platform enterprise information map display 1000 according with some embodiments. The map display 1000 may give an enterprise the ability to track the location of each of driver in a fleet. The enterprise can access this by viewing an updated map including each of the drivers. As long as a driver has a good signal, his or her location will update every time an enterprise refresh the screen. Selection of a driver icon 1010 may result in display of who the driver is, along with his or her basic information. Such a map display 1000 may, for example, increase company transparency and/or dispatching efficiency.

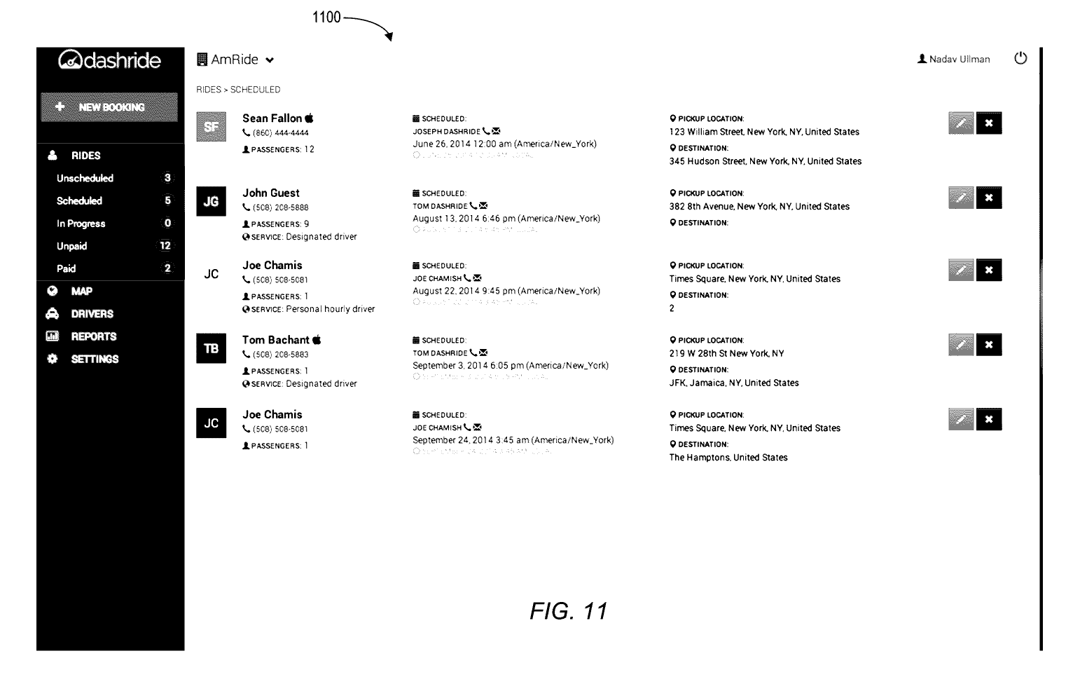

FIG. 11 illustrates a dispatch platform enterprise information new bookings display 1100 in accordance with some embodiments. When a customer calls with a ride request, selection of a ‘New Booking’ icon may let an enterprise enter some basic information about the customer. If it is a pre-existing customer, then the appropriate information will be automatically populated after a phone number is entered, including the customer's credit card information. When an enterprise selects a “Next” icon, additional ride details may be entered. According to some embodiments, an enterprise can customize the bookings display, such as by defining which information will be collected by call centers or dispatchers.

After the necessary information is collected, an enterprise can click ‘Create Ride.’ Depending on dispatching settings, the ride will then either be auto-assigned to a driver, broadcast to drivers, or the enterprise may manually dispatch the ride request to a selected driver. Once a driver is assigned a ride request, it will appear on that driver's smartphone application.

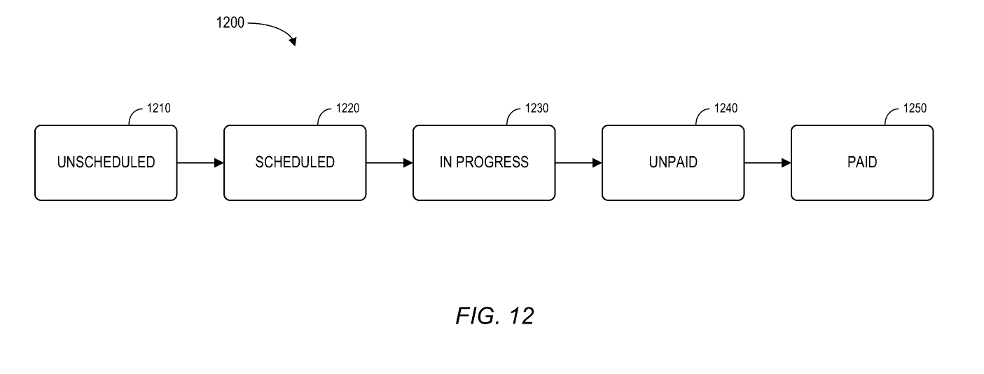

FIG. 12 illustrates phases 1200 of a ride according with some embodiments. When a ride is first booked, whether through an enterprise call center, a website or a mobile application, the ride request is first designated “Unscheduled” 1210. Once the ride is assigned a driver, either through auto-dispatching or manual assignment, the ride request becomes “Scheduled” 1220. At that stage, the client will automatically be notified that the ride request has been assigned to a vehicle. Once the driver marks “Arrived” on the driver application, the client will be automatically notified that his or her driver has arrived at their Pickup Location. Then the driver will swipe to “Start Ride” on the driver application. When this happens, the ride on the dispatching center will move from “Scheduled” 1220′ to “In Progress” 1230. When a driver clicks “Ride Complete” on the driver application, the ride will then move from “In Progress” to “Unpaid” 1240. The driver then clicks “Charge” on his or her application and once the ride is fully processed, it moves to the “Paid” phase 1250 tab. After the ride is “Paid” 1250, the enterprise may arrange to refund the client for either part of the ride or the full ride.

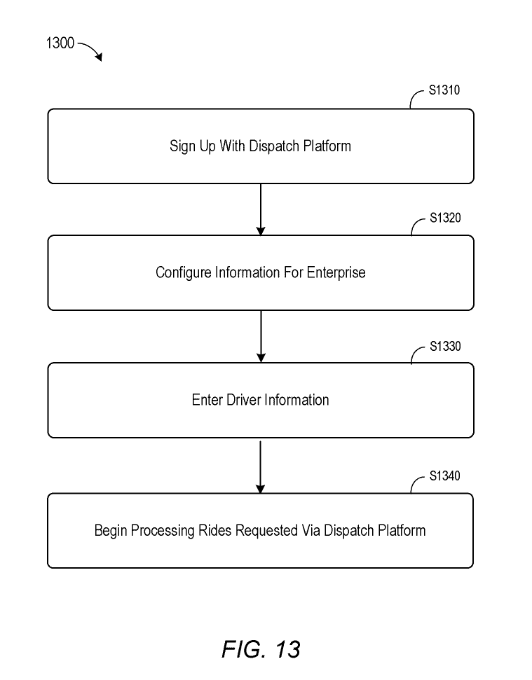

FIG. 13 is a flow diagram of a dispatch platform method 1300 in accordance with some embodiments. At S1310, an enterprise may sign up with the dispatch platform by providing some basic information (e.g., company name, contact information, etc.). At S1320, the enterprise may configure and customize the dispatch platform to create an individually branded customer experience. The enterprise may also define how the service will operate for customers (e.g., pricing information, dispatching decisions, affiliation program data, etc.). At S1330, the enterprise will provide driver information all of the drivers in the fleet. After those steps have been performed, the enterprise may begin processing ride requests via the dispatch platform at S1340. Note that a dispatch application may provide a full suite of cloud-based tools and mobile applications for auto-dispatching. According to some embodiments, features may let a user accept rides, organize a plurality of rides, access an in-application chat with clients, facilitate calls to clients, aid navigation, charge clients, and/or support an automated dispatch algorithm.

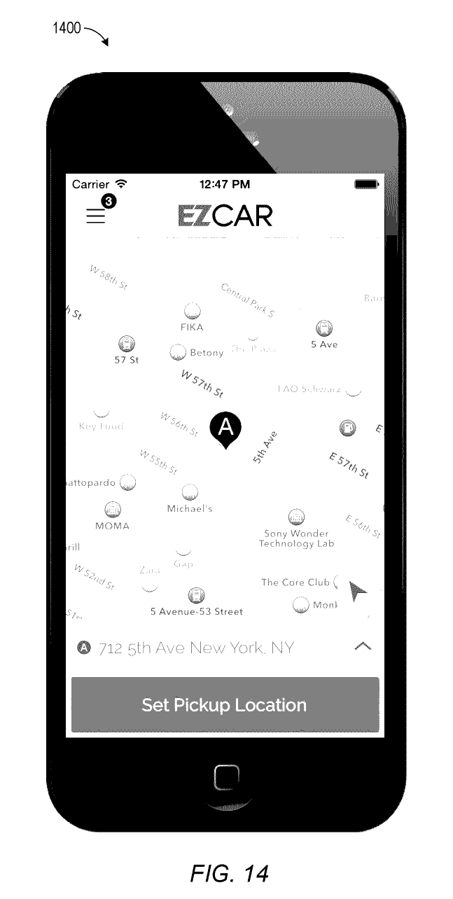

FIG. 14 illustrates a customer ride request display 1400 on a smartphone according with some embodiments. The display 1400 might include a map along with the customer's current location and local points of interest. The customer may use the display 1400, for example, to set a pickup location and transmit the request for a ride. Note that the ride request display 1400 may be customized for the particular enterprise and their fleet of vehicles (e.g., by including a logo associated with the enterprise, a tailored layout and/or color scheme, various navigation and information icons, etc.).

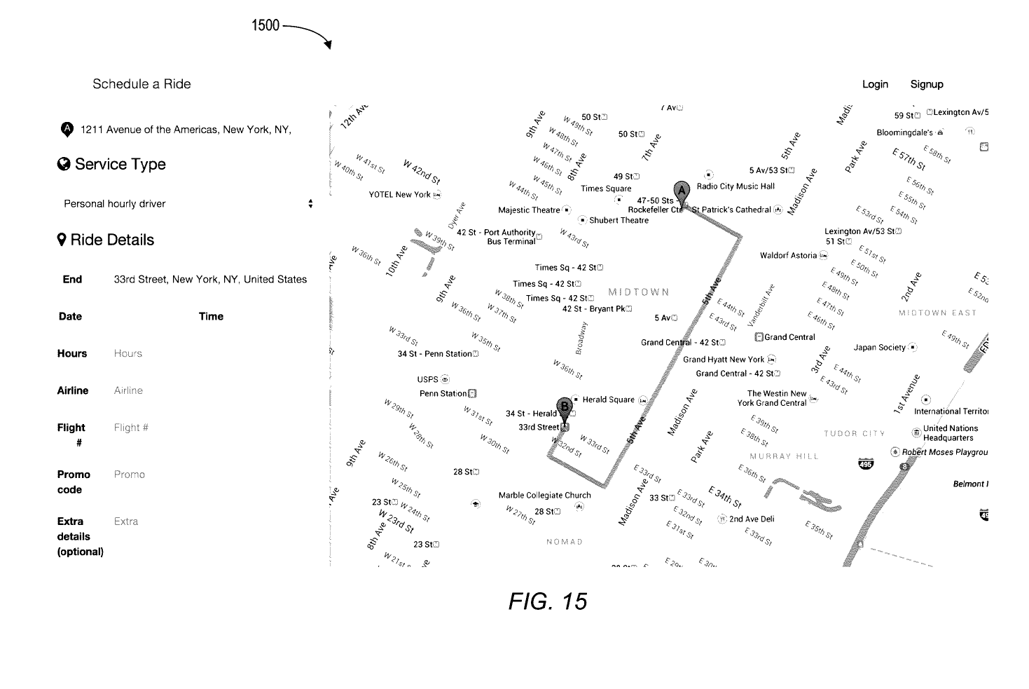

FIG. 15 illustrates a customer ride scheduling display 1500 on a web portal according with some embodiments. As with the display 1400 of FIG. 14, this display 1500 might include a map along with the customer's current location and local points of interest. The customer may use the display 1500, for example, to set a pickup location and transmit the request for a ride, schedule a request for a future ride, and/or provide additional information (e.g., an airline, terminal, flight number, and/or coupon code). Note that the ride scheduling display 1500 may be customized for the particular enterprise and their fleet of vehicles (e.g., by including a logo associated with the enterprise, a tailored layout and/or color scheme, various navigation and information icons, etc.).

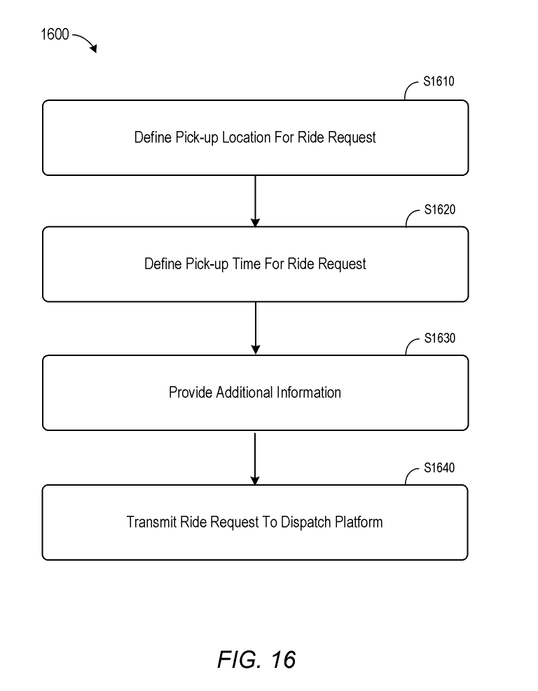

FIG. 16 is a flow diagram of a customer application method 1600 in accordance with some embodiments. At S1610, the customer may define a pick-up location for a ride request. The customer might, for example, indicate that his or her current location should be used, enter a street address or point of interest, or use a touch screen display and map to select the pick-up location. At S1620, the customer may define a pick-up time for a ride request. The customer might, for example, indicate that a vehicle should be dispatched as soon as possible or use a calendar display to select a future date and time. At S1630, the customer may provide additional information, such as an airport, airline name, flight number, etc. At S1640, the ride request may be transmitted to the dispatch platform. According to some embodiments, the customer may be allowed to rate the driver after the ride is complete.

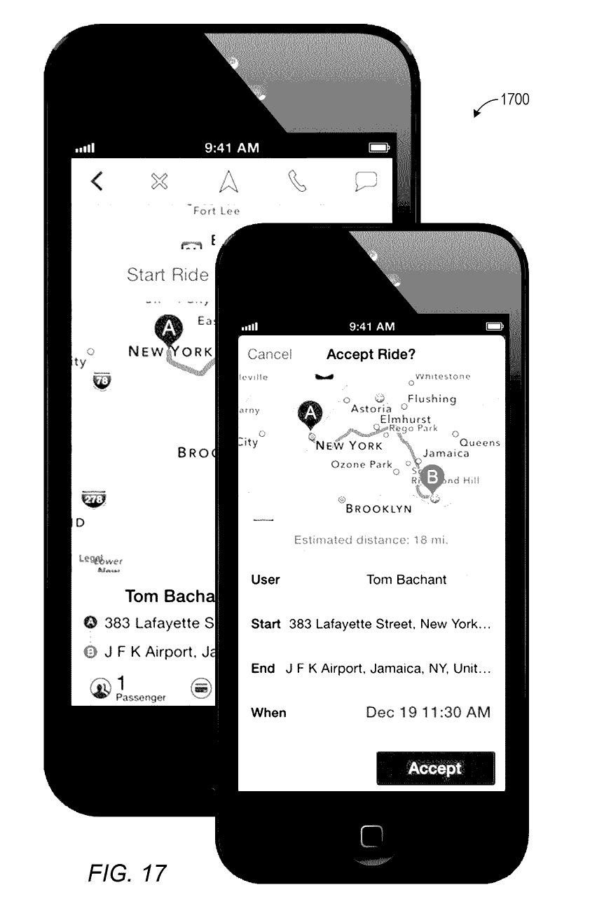

FIG. 17 illustrates a driver application display 1700 according with some embodiments. The driver display 1700 may include a map showing a vehicle's current location and/or the location of a potential customer. The driver display 1700 might also provide a user name, start and end locations for a ride (along with an estimated total travel distance between those two points), and a time and/or date associated with the ride request. The driver 1700 may use the display to indicate to the dispatch platform that he or she will dismiss or accept the ride request.

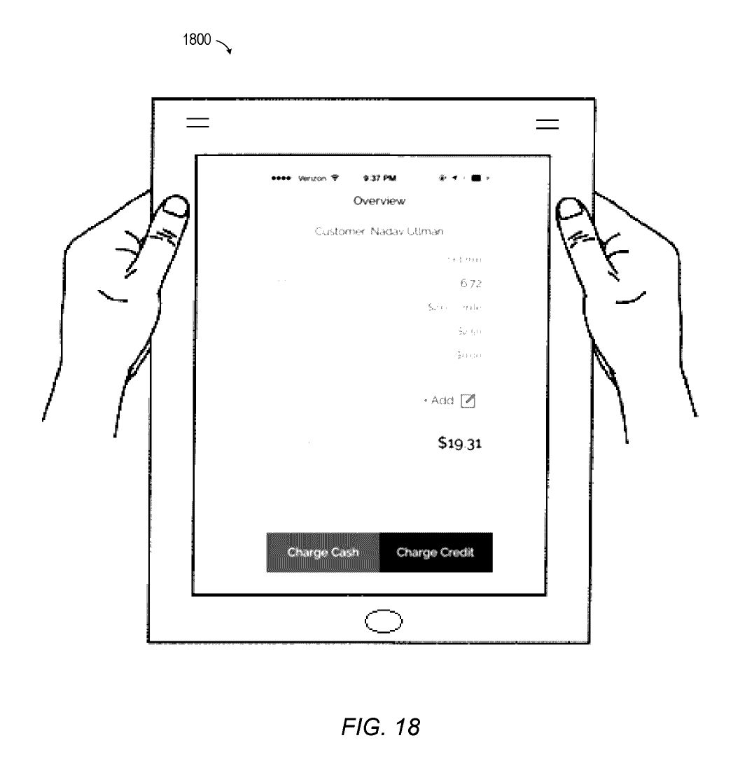

FIG. 18 illustrates a payment display 1800 according with some embodiments. The payment display 1800 might display a customer name, a duration of a completed ride, a number of miles traveled during the ride, a rate associated with the ride, a pick-up charge, a discount, a surcharge, and/or a sub-total amount associated with the ride. The payment display 1800 may be used, for example, to facilitate payment via cash, a credit card, a debit card, or an electronic payment process (e.g., an electronic wallet). Depending on how an enterprise runs their company, there may be several different ways customers can charged for a ride. For example, either an enterprise may have the driver charge the customers from the driver application, or an enterprise can have the dispatcher or admin bill the customer from the dispatching center. From a settings portion of a signup process, an enterprise might indicate if the enterprise wants to give drivers permission to charge the client cash, credit, or at all. If an enterprise allows drivers to process payments, and a credit card is on file, the client can be charged via the card right when the ride is over. If the driver does not charge a ride upon completion, a dispatcher can bill the customer by going into ‘Unpaid Rides’ and clicking CHARGE. Before the customer is charged, the system may add multiple types of surcharges. Once a customer is billed for a ride, he or she will automatically get an email receipt with the details and cost of the ride.

According to some embodiments, a dispatch platform may partner with a third party service for credit card processing. According to some embodiments, money is deposited into an appropriate account daily. After a ride is charged, an enterprise can see the ride in a “Paid Rides” list, and, if necessary, refunds may be provided for the whole, or part, of the ride. Completed rides may be compiled and provided in electronic reports.

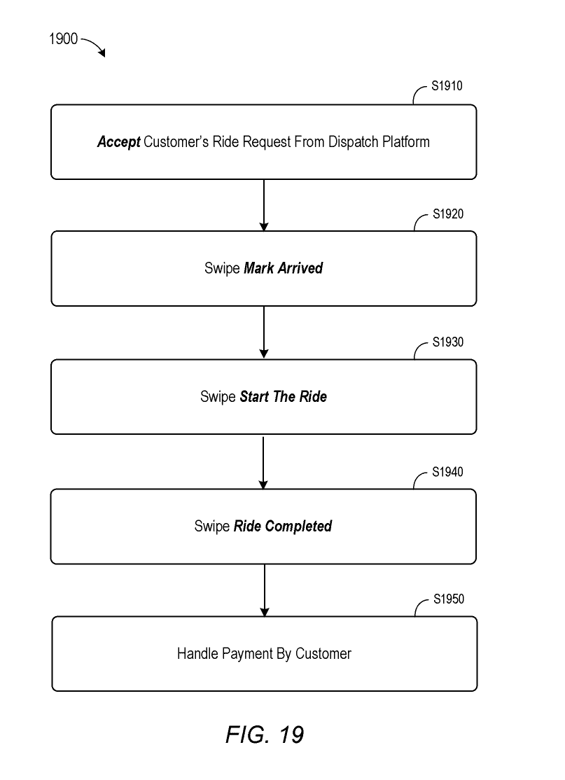

FIG. 19 is a flow diagram of a driver application method 1900 in accordance with some embodiments. Once a driver's email is added to the dispatching center, he or she may be able to view two lists: “My Rides” and “Available Rides.” Available rides may represent all the rides that are available for the driver to accept, and “My Rides” are all of the rides that have been accepted by that particular driver (including rides that are in progress). Once a driver accepts a ride from “Available” rides at S1910 no other driver is able to see that ride anymore. According to some embodiments, rides may show up in “Available Rides” in several different ways, depending on the customized dispatch platform settings for the enterprise. The driver can click on the ride to open it up, view more details, and accept the ride. Additionally, when a ride is accepted, it may be moved to the “Scheduled” list displayed for the dispatching center. Once a driver accepts a ride at S1910, he or she may view additional information about the ride. The driver might, for example, view the customer on a map, get directions to the pickup location, call the customer, and/or chat with the customer with an in-application chat function. If the customer requested the ride via the customer application, he or she can watch the driver on a map as the vehicle drives. When the driver arrives on-scene, he or she may Swipe to Mark Arrived at S1920. When the driver does this, the client may be alerted via a push notification that the driver has arrived.

Once the passenger is in the car, the driver can Swipe to Start the Ride at S1930. This may start what is essentially an in-application meter. Depending on how the pricing is set up in the dispatching center, the application may automatically start calculating a distance, a period of time, and/or flat rates. At the dispatching center, the ride may move to an “In-progress” list. At this point, the driver may also retrieve directions to the drop-off location. Once the driver has arrived at the drop-off location, he or she can Swipe to Complete ride at S1940. At the dispatching center, the ride may then move to an “Unpaid” list. This will stop the meter and calculate a total fare for that ride. After the ride has been marked complete at S1940, the driver application may then allow the driver to charge the client by cash or credit card at S1950. The driver may also be able to rate the client. From the dispatching center, an enterprise may have the ability to control these permissions and decide what the enterprise will let drivers to do after the ride. Some enterprises may only allow rides to be charged by credit card, others may only allow cash transactions, and still others may give both options.

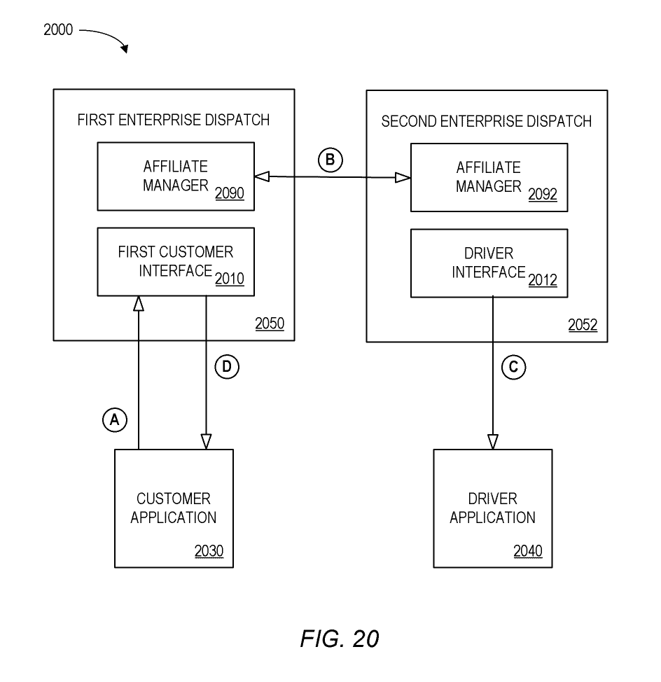

FIG. 20 is an affiliate program information flow diagram 2000 accordance with some embodiments. In this example, a first enterprise dispatch 2050 executes a first customer interface 2010 and an affiliate manager 2090. A second enterprise dispatch 2052 executes a driver interface 2012 and an affiliate manager 2092 (note that the second enterprise dispatch 2052 might also execute a second customer interface, not illustrated in FIG. 20). The first and second enterprises may, according to this example, be enrolled in affiliate program. For example, the first enterprise might be located in New York City and arrange for the second enterprise, located in Los Angeles, to serve its customers when appropriate. At (A), a customer application 2030 transmits a ride request to the first enterprise dispatch 2050 via the first customer interface 2010. The affiliate manager 2090 might realize that the customer is in Los Angeles and exchange information with affiliate manager 2092 of the second enterprise dispatch 2052 at (B). That is, the first enterprise is unable to respond to the ride request, and provides information to the second enterprise to see if it can accommodate the customer. The affiliate manager 2092 may arrange to accept the ride request (either at the same price offered by the enterprise or by transmitting an adjusted to price to the first enterprise that may be accepted by the customer) and transmit information to a driver application at (C) to dispatch a vehicle for the customer. The customer may then be informed via the first customer interface 2010 that the vehicle is en route at (D).

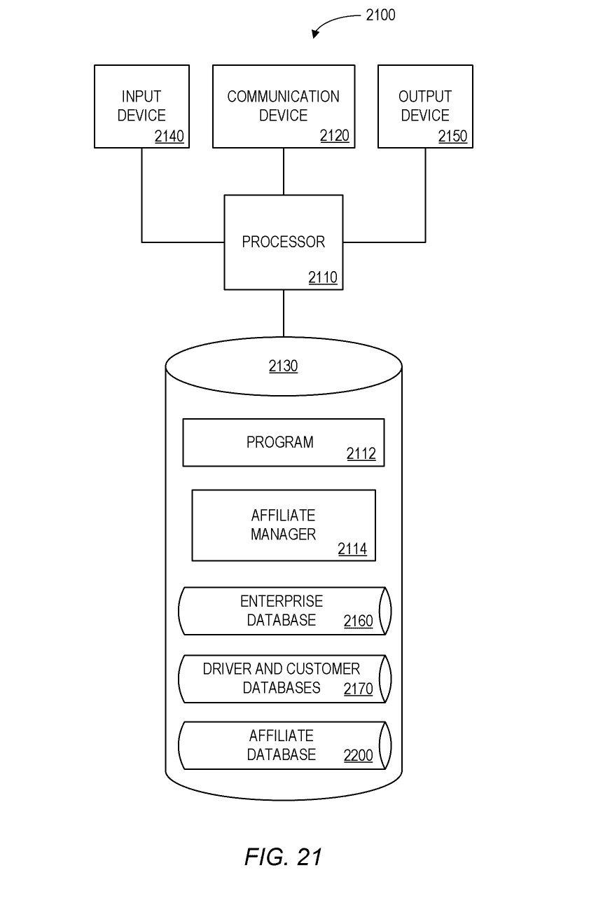

Note that the architectures described with respect to FIGS. 1 and 20 are provided only as examples, and any other types of apparatus might be provided instead. For example FIG. 21 is a block diagram overview of one such apparatus 2100 according to some embodiments. The apparatus 2100 may be, for example, associated with a dispatch platform and/or cloud service. The apparatus 2100 comprises a processor 2110, such as one or more commercially available Central Processing Units (CPUs) in the form of one-chip microprocessors, coupled to a communication device 2120 configured to communicate via a communication network (not shown in FIG. 21). The communication device 2120 may be used, for example, to exchange information with driver applications, customer applications, and/or other dispatch platforms. The apparatus 2100 further includes an input device 2140 (e.g., a mouse and/or keyboard to enter setup information associated with vehicles, drivers, zones, etc.) and an output device 2150 (e.g., a computer monitor to display administrative information, maps with vehicle locations, reports, real-time analytic data, etc.).

The processor 2110 communicates with a storage device 2130. The storage device 2130 may comprise any appropriate information storage device, including combinations of magnetic storage devices (e.g., a hard disk drive), optical storage devices, and/or semiconductor memory devices. The storage device 2130 stores a program 2112 and/or virtual environment engine 2114 for controlling the processor 2110. The processor 2110 performs instructions of the programs 2112, 2114, and thereby operates in accordance with any of the embodiments described herein. For example, the processor 2110 might, based on information about a first enterprise having a first fleet of vehicles, execute a first customer interface for the first enterprise, the first customer interface being adapted to receive ride requests from customers via the communication device 2120. The processor 2110 might also facilitate an establishment of an affiliate link between the first enterprise and a second enterprise. The processor 2110 may also receive, via the first customer interface, a ride request from a first customer. It may then be automatically determined that the first customer is located geographically proximate to the second enterprise. Based on the affiliate link between the first enterprise and the second enterprise, the processor 2110 may arrange for a vehicle from the second fleet of vehicles to be assigned to the ride request.

The programs 2112, 2114 may be stored in a compressed, uncompiled and/or encrypted format. The programs 2112, 2114 may furthermore include other program elements, such as an operating system, a database management system, and/or device drivers used by the processor 2110 to interface with peripheral devices.

As used herein, information may be “received” by or “transmitted” to, for example: (i) the apparatus 2100 from another device; or (ii) a software application or module within the apparatus 2100 from another software application, module, or any other source.

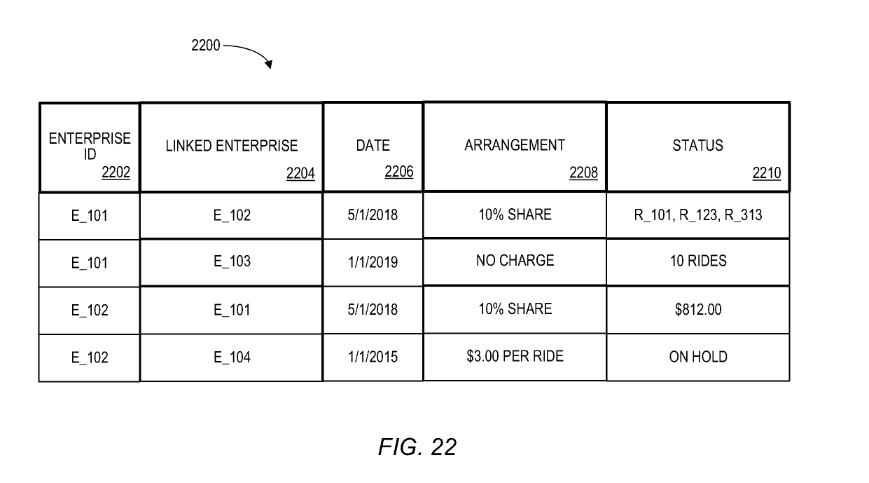

In some embodiments (such as shown in FIG. 21), the storage device 2130 stores an enterprise database 2160, driver and customer databases 2170 (e.g., include the fleet of vehicles and registered user), and an affiliate database 2200. An example of an affiliate database 2200 that may be used in connection with the apparatus 2100 will now be described in detail with respect to FIG. 22. Note that the database described herein is only an example, and additional and/or different information may be stored therein. Moreover, various databases might be split or combined in accordance with any of the embodiments described herein.

Referring to FIG. 22, a table is shown that represents the affiliate database 2200 that may be stored at the apparatus 2100 according to some embodiments. The table may include, for example, entries identifying one or more enterprises that may be used to serve customers. The table may also define fields 2202, 2204, 2206, 2208, 2210 for each of the entries. The fields 2202, 2204, 2206, 2208, 2210 may, according to some embodiments, specify: an enterprise identifier 2202, a linked enterprise 2204, a date 2206, an arrangement 2208, and a status 2210. The information in the business data 2200 may be created and updated, for example, based on data received from dispatch portals and/or affiliate managers.

The enterprise identifier 2202 may be, for example, a unique alphanumeric code identifying an enterprise having a fleet of vehicles. The linked enterprise 2204 may be, for example, a unique alphanumeric code identifying another enterprise and may be based on or otherwise associated with the enterprise identifier 2202. In the example of FIG. 22, enterprise E_101 has agreed to send customers to E_102 as shown by the first row in the table (and the reverse is also true as shown in the third row). The date 2206 might indicate when the link was established. The arrangement 2208 might define a compensation structure for referrals (e.g., and may involve a flat fee, a percentage, or no financial exchange). The status 2210 might indicate, for example, a list of referred rides, an amount of money, a total number of rides, etc.

Thus, some embodiments may establish methods and mechanisms to efficiently, accurately, and automatically facilitate administration of a dispatch platform affiliate program. Moreover, embodiments may provide a branded consumer application for a fleet of vehicles. According to some embodiments, an enterprise may be able to help customers even when they are outside the enterprise's area of operation. Still further, embodiments may provide a point of sale, auto-dispatch features, a map of where the driver is, an ability to chat directly with a driver, process payments for rides with credit cards, automatically generate a cost estimate, and let customer's rate a driver after his or her ride.

According to some embodiments, an affiliate network may connect a number of existing clients (e.g., clients of an enterprise) to each other, allowing each client to leverage and share a driver base and a customer base. The network may also arrange for clients to fulfill end-consumer (passenger) requests rides anywhere that a participating fleet exists. By way of example, consider Limousine Company A that has a branded customer application called “Limo A” and operates in New York City. A Limousine Company B has a barnded customer application called “Limo B” and operates in Chicago. Both Company A and Company B participate in an affiliate network in accordance with any of the embodiments described herein. As a result, Company A can tell their consumers that they can use the Limo A application in both New York City and Chicago. As Company A connects to more and more fleets across the country, they can eventually tout to passengers that Limo A is a national brand.

When a customer of Company A uses the Limo A application in Chicago, the system will automatically detect that he or she is in Chicago and send the ride using Company B's fleet of vehicles. Note that A company might have the ability to pick and choose which fleets (and/or in which areas) it prefers to work with, or opt in to auto-dispatch out to all of the fleets in an area, in which case the system may determine the closest available driver to the customer, regardless of what fleet is associated with the driver.

Some embodiments described herein may also automate payouts to ensure that both parties get paid as appropriate. For example, Company A from New York might collect a percentage of the ride's cost, since it was their customer, while Company B from Chicago collect a percentage of the ride's cost, because their driver fulfilled the ride. This may give clients of an enterprise the ability to have coverage around the world, even though they are just a local fleet. Moreover, the process may be automated too read where the consumer is and to find the correct fleet to receive the auto-dispatch. In addition to (or instead of) letting transportation companies connect to other companies in different areas, embodiments may be provided such that an affiliate network facilitates connections with companies in the same area to expand driver availability. For example, if a ride is booked into a transportation application, the ride would first dispatch to the company's own drivers, one by one. If, however, the drivers of that particular company are unable to fulfill that ride, the system can start to dispatch the ride out to drivers of other companies in the area to ensure that the ride is fulfilled.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to an affiliate program based on geographic location, note that embodiments may be associated with other types of affiliate programs. For example, “overflow” ride requests or requests for particular types of vehicles not offered by an enterprise may be processed in accordance with any of the embodiments described herein. According to some embodiments, a customer interface may receive an additional ride request from a customer. In this case, it may be automatically determined that none of a fleet of vehicles are available to be assigned to the additional ride request (e.g., all vehicles may be currently “in progress”). In this case, based on an affiliate link between the enterprise and another enterprise, it may be arranged for a vehicle from another fleet of vehicles, associated with the other enterprise, to be assigned to the additional ride request.

Moreover, although examples have been described with respect to two enterprises for clarity, note that actual embodiments may be associated with any number of enterprises. Moreover, an enterprise might establish an affiliate relationship with ten different limousine providers in a single city. In this case, one of the ten might be selected to receive a ride referral in any of a number of different ways (round-robin, financial considerations, the number of referrals received from each of the ten providers, etc.).

Moreover, while embodiments have been illustrated using particular display devices, embodiments may be implemented in any other of a number of different ways. For example, some embodiments might be associated with tablet computers, smartphones, smartwatches, etc.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer implemented method, comprising:
receiving information about a first enterprise having a first fleet of vehicles;
creating a first customer interface for the first enterprise, the first customer interface being adapted to receive, at a first dispatch platform, ride requests from customers via at least one communication network;
receiving information about a second enterprise having a second fleet of vehicles, the second enterprise being located geographically remote from the first enterprise;
creating a second customer interface for the second enterprise, the second customer interface being adapted to receive, at a second dispatch platform, ride requests from customers via at least one communication network;
establishing an affiliate link between the first enterprise and the second enterprise;
receiving, via the first customer interface, a ride request from a first customer;
automatically determining that the first customer is located geographically proximate to the second enterprise; and
based on the affiliate link between the first enterprise and the second enterprise, arranging for a vehicle from the second fleet of vehicles to be assigned to the ride request.

2. The method of claim 1, wherein the first enterprise is associated with at least one of: (i) a limousine service, (ii) a taxi service, and (iii) a livery service.

3. The method of claim 1, wherein the first customer interface is associated with at least one of: (i) a smartphone application, (ii) a web portal, (iii) a smartwatch, (iv) a handheld computer, (v) a table computer, (vi) a set-top box, and (vii) a gaming device.

4. The method of claim 1, further comprising:
facilitating a transfer of a benefit from the second enterprise to the first enterprise.

5. The method of claim 4, wherein the benefit comprises a monetary payment.

6. The method of claim 5, wherein the monetary payment has a value based on at least one of: (i) a pre-determined amount, (ii) a percentage of a fee paid from the first customer to the second enterprise, and (iii) a compensation formula.

7. The method of claim 1, further comprising:
receiving, via the first customer interface, an additional ride request from a second customer;
automatically determining that none of the first fleet of vehicles are available to be assigned to the additional ride request; and
based on an affiliate link between the first enterprise and a third enterprise, arranging for a vehicle from a third fleet of vehicles, associated with the third enterprise, to be assigned to the additional ride request.

8. The method of claim 1, wherein the first and second dispatch platforms are co-hosted in a cloud environment.

9. The method of claim 1, wherein said receiving information about the first enterprise includes receiving at least one of: (i) an enterprise name, (ii) enterprise contact information, (iii) auto-dispatching information, (iv) service information, (v) coupon code information, (vi) zone information, (vii) driver information, (viii) account information, (ix) GPS information, and (x) map information.

10. The method of claim 1, wherein the first and second customer interfaces are independently branded.

11. The method of claim 1, wherein the ride request comprises at least one of: (i) a request for an immediate pickup, and (ii) a request to schedule a future pickup.

12. The method of claim 1, wherein said arranging for the vehicle from the second fleet of vehicles to be assigned to the ride request includes displaying the ride request to drivers of the second fleet as a potential pickup and receiving from one of the drivers an acceptance of the potential pickup.

13. The method of claim 1, further comprising:
facilitating payment from the customer to the second enterprise.

14. The method of claim 1, further comprising:
collecting rating information from at least one of: (i) the customer, and (ii) a driver who picked up the customer.

15. A non-transitory, computer-readable medium storing program code executable by a computer to perform a method, the method comprising:
receiving information about a first enterprise having a first fleet of vehicles;
creating a first customer interface for the first enterprise, the first customer interface being adapted to receive, at a first dispatch platform, ride requests from customers via at least one communication network;
receiving information about a second enterprise having a second fleet of vehicles, the second enterprise being located geographically remote from the first enterprise;
creating a second customer interface for the second enterprise, the second customer interface being adapted to receive, at a second dispatch platform, ride requests from customers via at least one communication network;
establishing an affiliate link between the first enterprise and the second enterprise;
receiving, via the first customer interface, a ride request from a first customer;
automatically determining that the first customer is located geographically proximate to the second enterprise; and
based on the affiliate link between the first enterprise and the second enterprise, arranging for a vehicle from the second fleet of vehicles to be assigned to the ride request.

16. The medium of claim 15, wherein the first enterprise is associated with at least one of: (i) a limousine service, (ii) a taxi service, and (iii) a livery service; and further wherein the first customer interface is associated with at least one of: (i) a smartphone application, (ii) a web portal, (iii) a smartwatch, (iv) a handheld computer, (v) a table computer, (vi) a set-top box, and (vii) a gaming device.

17. The medium of claim 15, wherein the method further comprises:
facilitating a transfer of a benefit from the second enterprise to the first enterprise, wherein the benefit comprises a monetary payment having a value based on at least one of: (i) a pre-determined amount, (ii) a percentage of a fee paid from the first customer to the second enterprise, and (iii) a compensation formula.

18. The medium of claim 15, wherein the method further comprises:
receiving, via the first customer interface, an additional ride request from a second customer;
automatically determining that none of the first fleet of vehicles are available to be assigned to the additional ride request; and
based on an affiliate link between the first enterprise and a third enterprise, arranging for a vehicle from a third fleet of vehicles, associated with the third enterprise, to be assigned to the additional ride request.

19. The medium of claim 1, wherein the first and second dispatch platforms are co-hosted in a cloud environment.

20. A system, comprising:
an input port to receive: (i) information about a first enterprise having a first fleet of vehicles, (ii) information about a second enterprise having a second fleet of vehicles, the second enterprise being located geographically remote from the first enterprise, and (iii) a ride request from a first customer via the first customer interface;
a dispatch platform coupled to the input path, to:
create a first customer interface for the first enterprise, the first customer interface being adapted to receive, at a first dispatch platform, ride requests from customers,
create a second customer interface for the second enterprise, the second customer interface being adapted to receive, at a second dispatch platform, ride requests from customers,
establish an affiliate link between the first enterprise and the second enterprise,
determine that the first customer is located geographically proximate to the second enterprise, and
based on the affiliate link between the first enterprise and the second enterprise, arrange for a vehicle from the second fleet of vehicles to be assigned to the ride request.

21. The system of claim 20, wherein the first enterprise is associated with at least one of: (i) a limousine service, (ii) a taxi service, and (iii) a livery service; and further wherein the first customer interface is associated with at least one of: (i) a smartphone application, (ii) a web portal, (iii) a smartwatch, (iv) a handheld computer, (v) a table computer, (vi) a set-top box, and (vii) a gaming device.

22. The system of claim 20, wherein the dispatch platform is further to:
facilitate a transfer of a benefit from the second enterprise to the first enterprise, wherein the benefit comprises a monetary payment having a value based on at least one of: (i) a pre-determined amount, (ii) a percentage of a fee paid from the first customer to the second enterprise, and (iii) a compensation formula.

23. The system of claim 20, wherein the dispatch platform is further to:
receive via the first customer interface, an additional ride request from a second customer,
automatically determine that none of the first fleet of vehicles are available to be assigned to the additional ride request, and
based on an affiliate link between the first enterprise and a third enterprise, arrange for a vehicle from a third fleet of vehicles, associated with the third enterprise, to be assigned to the additional ride request.
